(19) United States
(12) Patent Application Publication
(10) Pub. No.: US 2016/0114741 A1
(43) Pub. Date: Apr. 28, 2016

(54) RDefender License Plate Tag Protector

(71) Applicant: Ralph Dudley, Rowland Heights, CA (US)

(72) Inventor: Ralph Dudley, Rowland Heights, CA (US)

(21) Appl. No.: 14/522,591

(22) Filed: Oct. 24, 2014

(51) Int. Cl. B60R 13/10

(52) U.S. Cl. CPC B60R 13/105

(57) ABSTRACT

The Invention is an improved license plate and tag protector, comprised in a single piece, and made of plastic (with an SPI code of 1-7), stainless steel, zinc alloy, brass, wood, and/or can be made with any other material that may be formed and/or constructed through molding and/or non-molding processes and/or devices into the current inventions design. The license plate tag protector further comprises an improved structural technique for positioning and securing registration and or identifying decals on license plates mitigating propensity for theft, wear and tear. A method of making a license plate tag protector as described can both be made with and without molding devices based on material selection. The invention calls for both front and back plate structural specifications as indicated below.

This application claims priority to provisional application No. 61/895,866 filed on Oct. 25, 2013.

### DESCRIPTION

### Background of the Invention

While vehicle registration tag theft is not a calculated statistic for the Department of Motor Vehicles, for the consumers and employers inconvenienced by tag theft it equates to time off work and the cost of a replacement tag. Cumulatively this is a widespread issue necessitating tag theft warnings by both State and Federal agencies. The use of license plate protection devices is known in the prior art. More specifically, registration tag protection devices are known to consist basically of familiar, expected and obvious structural configurations, notwithstanding the myriad of designs encompassed by the prior art which have been developed for multiple objectives and requirements.

The use of vehicle license plate mounts and registration sticker protectors are known in the prior art. Such vehicle license plate mounts and registration sticker protectors consist of structural configurations that are familiar, expected and obvious.

By way of example, the prior art includes:
U.S. D308849 S: License Plate Sticker Lock
U.S. Pat. No. 6,892,483: Reversible locking license plate registration sticker tag protection frame
U.S. Pat. No. 2,190,571 A: License tag cover
U.S. Pat. No. 6,385,876 B1: Lockable license plate cover assembly
U.S. Pat. No. 5,819,449 A: Protective nonstick cover for license plate
U.S. Pat. No. 5,381,618 A: Security frame for vehicle license plates
U.S. Pat. No. 5,983,539 A: Tag lock

In these respects, the license plate and registration tag protection frame assembly of the present invention substantially departs from the conventional concepts and designs of the prior art, and in so doing provides a device that fulfills the need for new and improved license plate and registration tag protection and design capabilities.

Through the use of design and durability testing the present invention encompasses all the advantages of the prior art and mitigates or eliminates all the disadvantages.

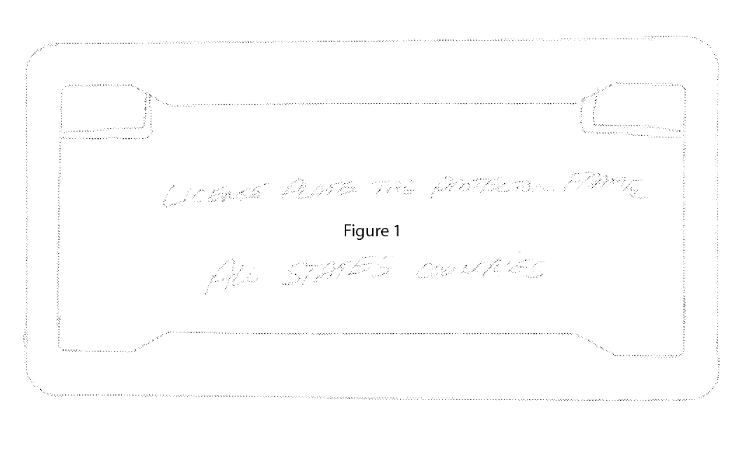

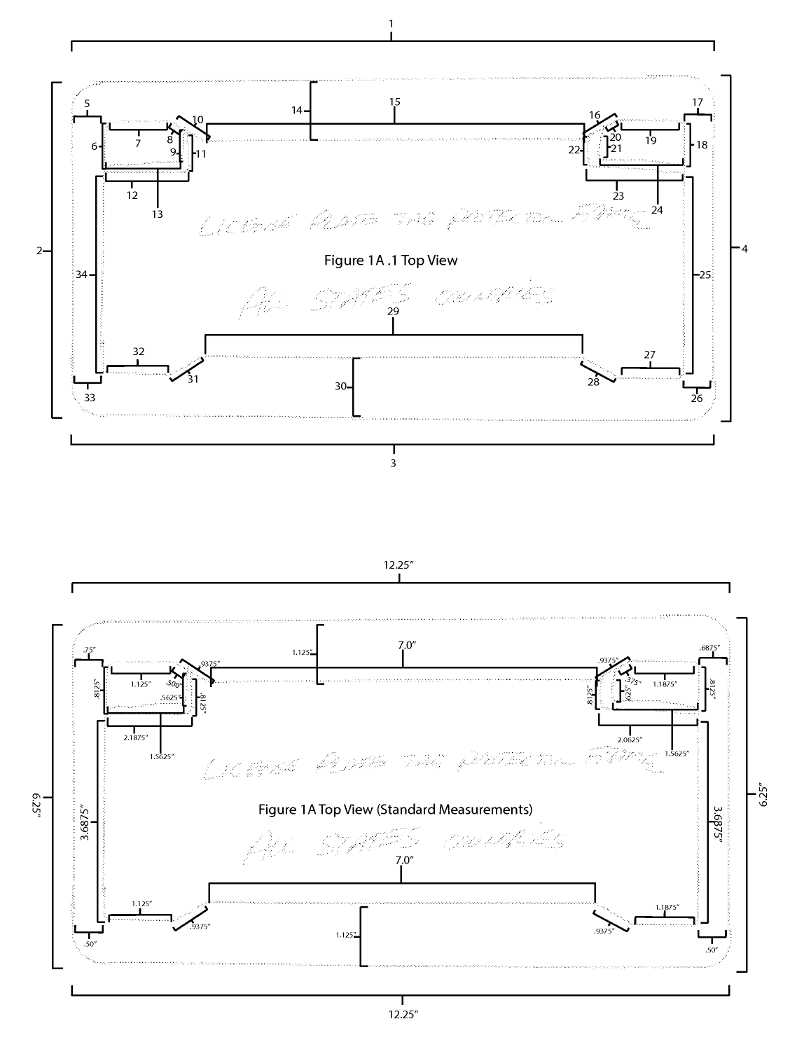

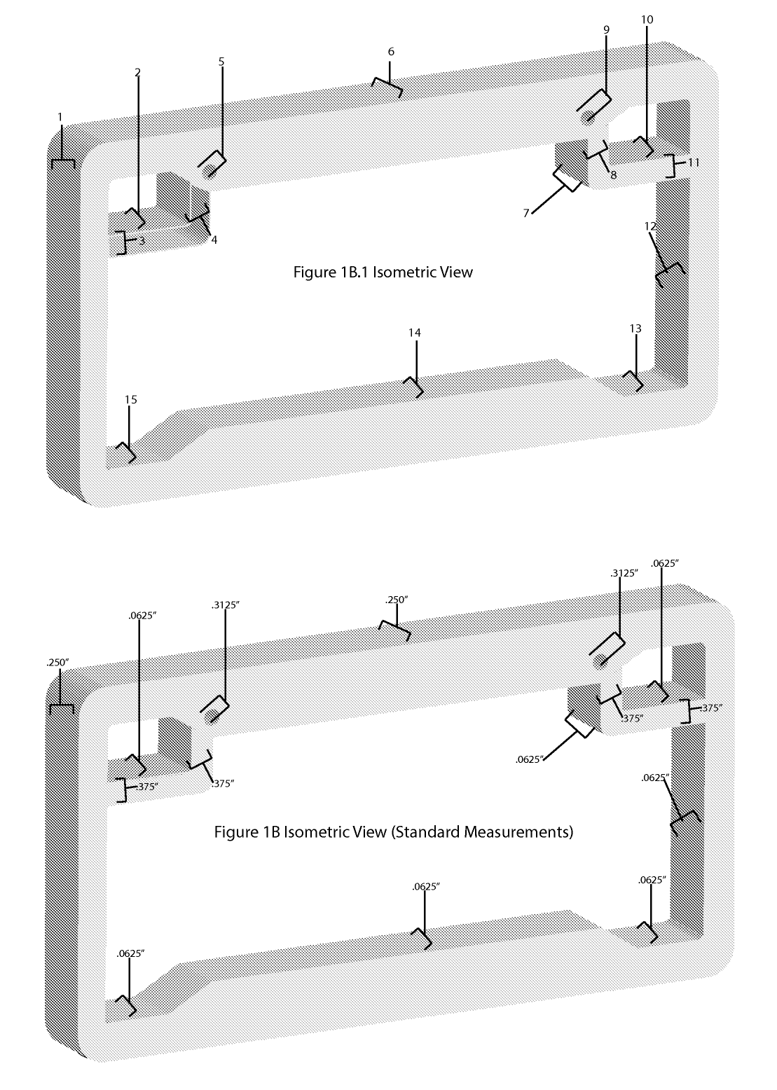

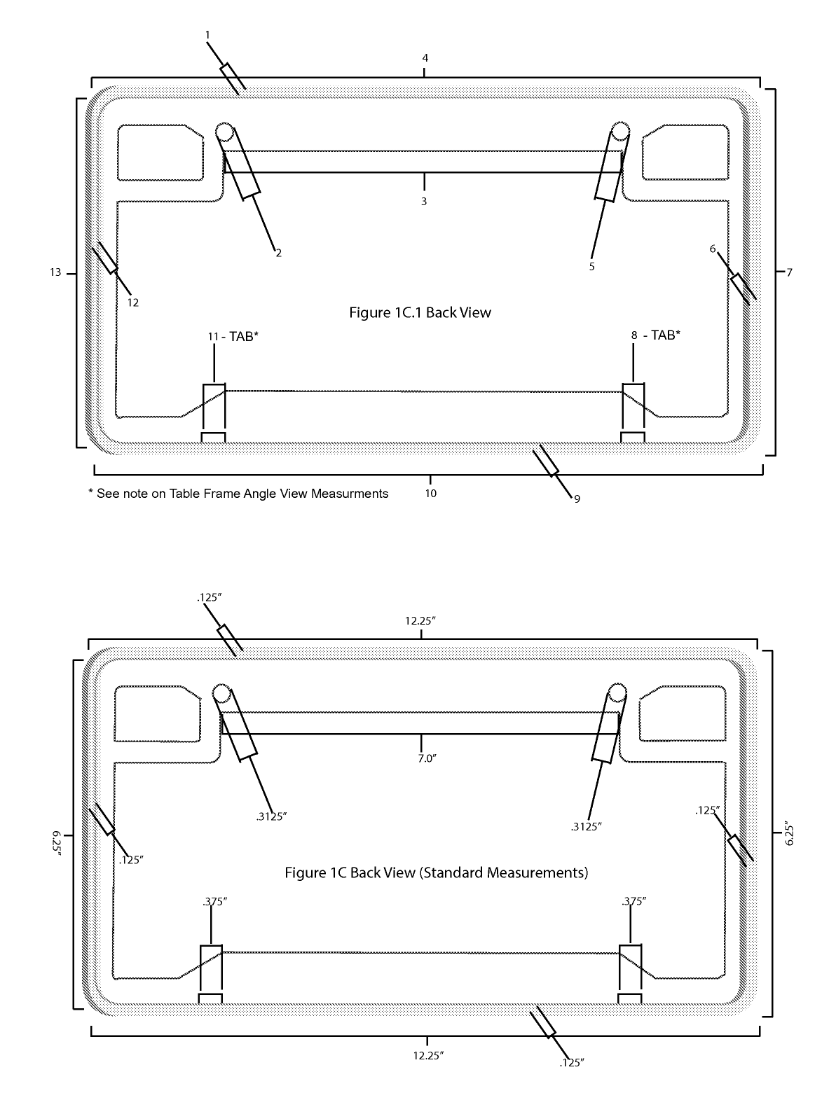

To achieve this, the present invention essentially comprises the same elements of a standard license plate frame with the exception of the addition of one or more loop structures as represented by FIGS. 1a-1c, 2a-2c, 3a-3f, and 4 (front of vehicle frame) which will be detailed in more depth below.

As shown in the Figures, the invention is defined by a planar rectangular elongated top face, a planar rectangular elongated bottom face, and a pair of planar rectangular short side faces coupled there between. The frame for the vehicle back license plate loop portion of the design is a congruent part of the whole and is not an attachment but a single part of the whole and allows for the edges of the tags to be covered within the guidelines specified by the regulatory authorities. The frame for the vehicle front license plate loop portion of the design is a solid congruent part of the whole and is not an attachment but a single part of the whole and allows for greater advertising and design space.

This brief description of the primary features of the invention was presented to provide greater understanding of the more detailed description that follows and to appreciate the contributions to the art. The additional features of the invention that will be described hereinafter will form the subject matter of the claims appended hereto.

The invention is not limited in its application to the details of construction and/or to the arrangements of the components set forth in the following description or illustrated in the drawings. The invention is capable of other embodiments and of being practiced and carried out in various ways. Semantics and terminology herein are for the purpose of description and should not be regarded as limiting.

In addition, claims should be regarded as including such equivalent constructions insofar as they do not depart from the spirit and scope of the present invention. As indicated previously, it is the purpose of the present invention to provide a new and improved license plate and registration tag protection device which has all the advantages of the prior art license plate protection devices and none of the disadvantages for the back of vehicle; and, to provide a new and improved license plate device for the front of the vehicle with greater design and advertising space. The invention is easily and efficiently manufactured and marketed as more than a license plate frame but rather a tag defender in a durable, consistent, and reliable construction with consumer affordability.

The embodiments of the invention, coupled with the accompanying drawings and descriptive matter and claims, provides a clear understanding of the operating advantages and distinct characteristics that present a significant improvement to the current market art in this area.

### DESCRIPTION OF THE FIGURES

I, Ralph Dudley, have invented a new design for a license plate frame for front and rear vehicle display, as set forth in the following specifications. The claimed frames will be used to deter registration and tag theft, wear and tear of license plates, and provide greater advertising space for promotional usage. Front and Back vehicle designs can be manufactured and sold separately or as a pair and therefore claims are presented for all purposes.

### Back Vehicle Frame

FIG. 1 is a front top elevation view of the tag protector back of vehicle frame design;

FIG. 1A is a front top elevation view of the tag protector back of vehicle frame design listing standard sizes by way of example only and is not intended to be limiting.

FIG. 1A.1 is a front top elevation view of the tag protector back of vehicle frame design calling out various component parts of the design to be detailed in the claims.

NOTE: FIGS. 1, 1A, and 1A.1 depict tag protector back of vehicle frame design without mounting holes shown as an illustrative view of the design and is not intended to be limiting the scope or design of the current invention. Hole placement may vary based on operating vehicle requirements

FIG. 1B is an isometric view of the tag protector back of vehicle frame design listing standard sizes by way of example only and is not intended to be limiting.

FIG. 1B.1 is an isometric view of the tag protector back of vehicle frame design calling out various component parts of the design to be detailed in the claims.

FIG. 1C is a back elevation view of the tag protector back of vehicle frame design listing standard sizes by way of example only and is not intended to be limiting.

FIG. 1C.1 is a back elevation view of the tag protector back of vehicle frame design calling out various component parts of the design to be detailed in the claims.

NOTE: FIGS. 1B, 1B.1, 1C and 1C.1 depict tag protector back of vehicle frame design with mounting holes shown on top horizontal planar view as an illustrative view of the design and is not intended to be limiting the scope or design of the current invention. Hole placement may vary based on operating vehicle requirements

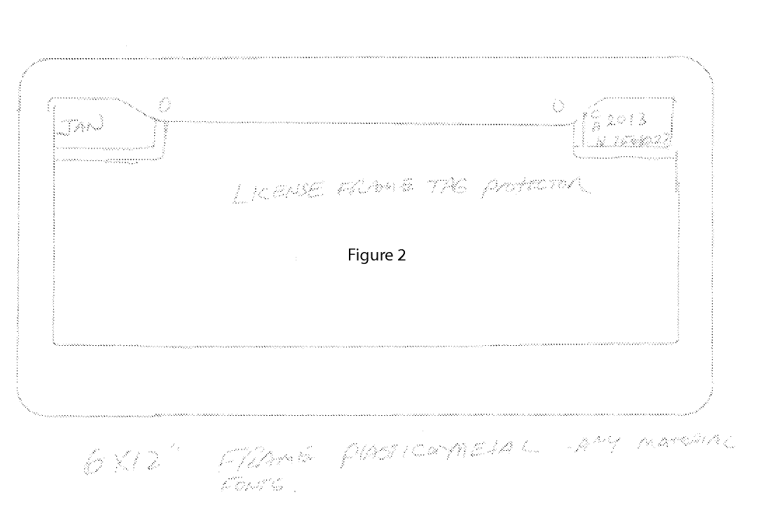

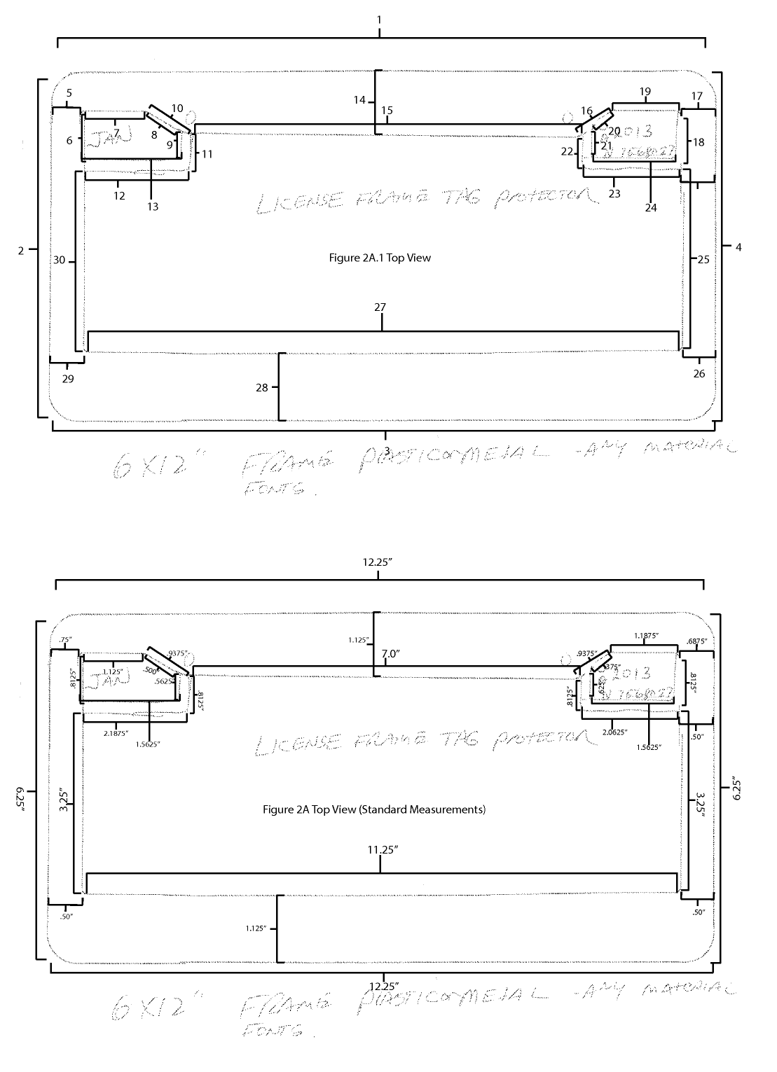

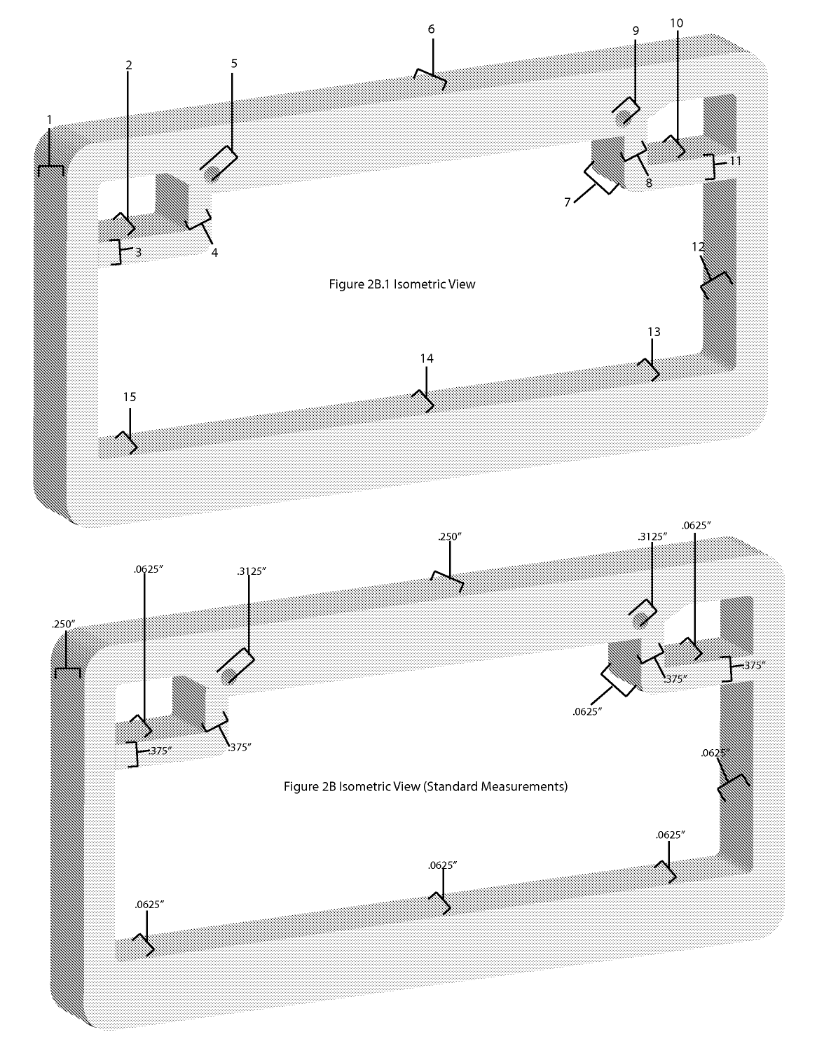

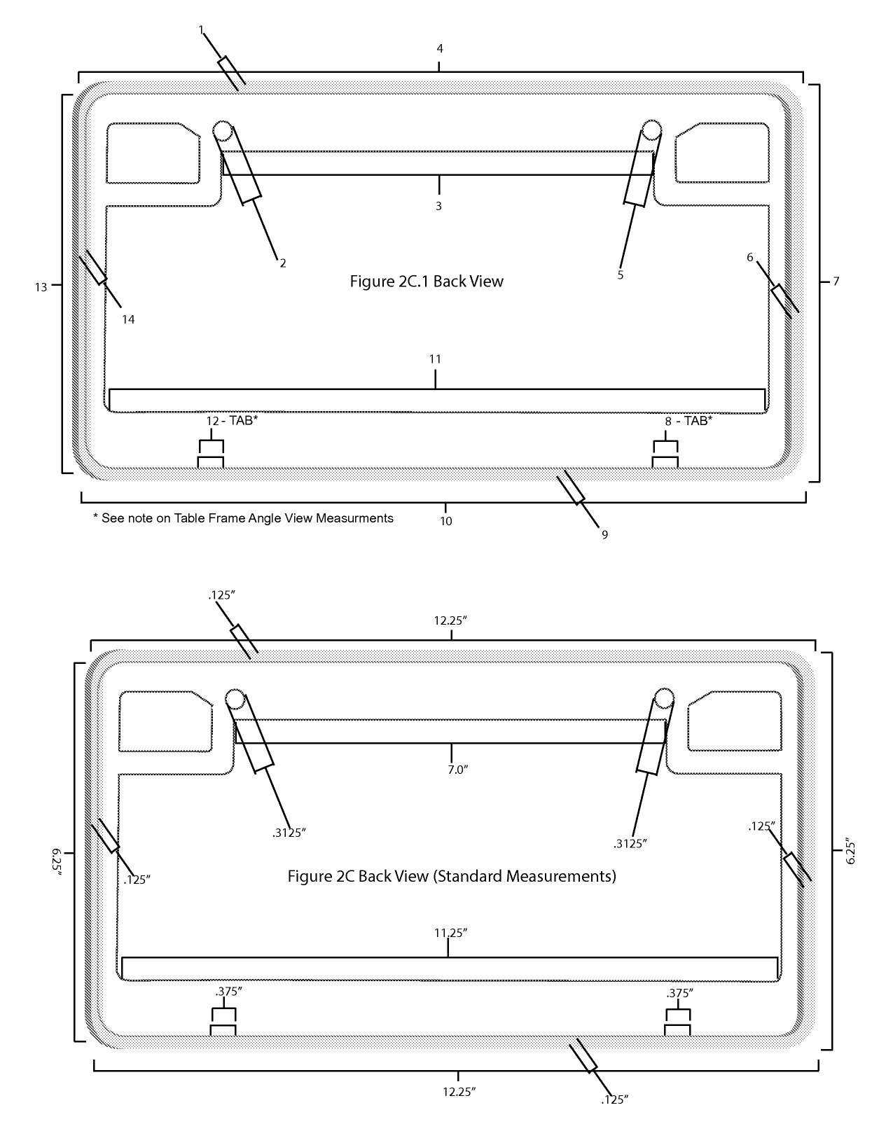

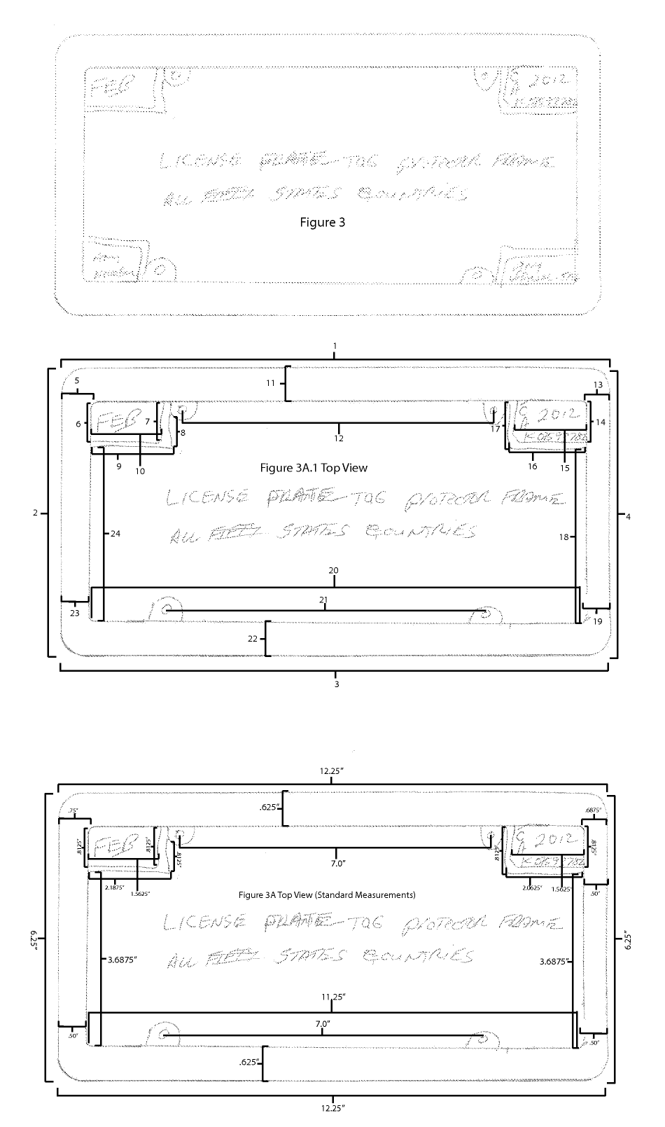

FIG. 2 is a front top elevation view of the tag protector back of vehicle frame design showing possible placements of the loop based on various state regulatory specifications by way of example only and is not intended to be limiting;

FIG. 2A is a front top elevation view of the tag protector back of vehicle frame design showing only the top corner positioning of the loops and listing standard sizes by way of example only and is not intended to be limiting nor reflecting all possible loop placements or sizes.

FIG. 2A.1 is a front top elevation view of the tag protector back of vehicle frame design showing only the top corner positioning of the loops and calling out various component parts of the design to be detailed in the claims, by way of example only; and, is not intended to be limiting nor reflective of all possible loop placements.

FIG. 2B is an isometric view of the tag protector back of vehicle frame design showing only the top corner positioning of the loops and listing standard sizes by way of example only and is not intended to be limiting nor reflecting all possible loop placements or sizes.

FIG. 2B.1 is an isometric view of the tag protector back of vehicle frame design showing only the top corner positioning of the loops and calling out various component parts of the design to be detailed in the claims, by way of example only; and, is not intended to be limiting nor reflective of all possible loop placements.

FIG. 2C is a back elevation view of the tag protector back of vehicle frame design showing only the top corner positioning of the loops and listing standard sizes by way of example only and is not intended to be limiting nor reflecting all possible loop placements or sizes.

FIG. 2C.1 is a back elevation view of the tag protector back of vehicle frame design showing only the top corner positioning of the loops and calling out various component parts of the design to be detailed in the claims, by way of example only; and, is not intended to be limiting nor reflective of all possible loop placements.

NOTE: FIGS. 2, 2A, 2A.1, 2B, 2B.1, 2C, and 2C.1 depict tag protector back of vehicle frame design with mounting holes shown on top horizontal planar view as an illustrative view of the design and is not intended to be limiting the scope or design of the current invention. Hole placement may vary based on operating vehicle requirements

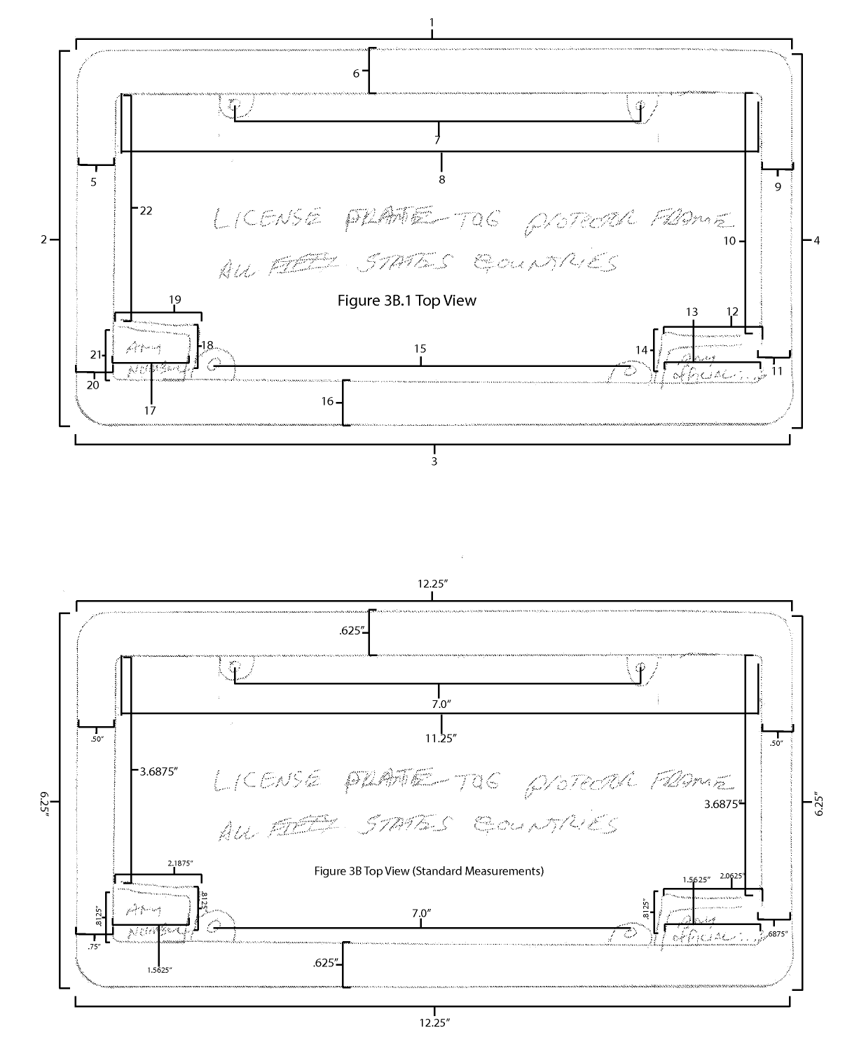

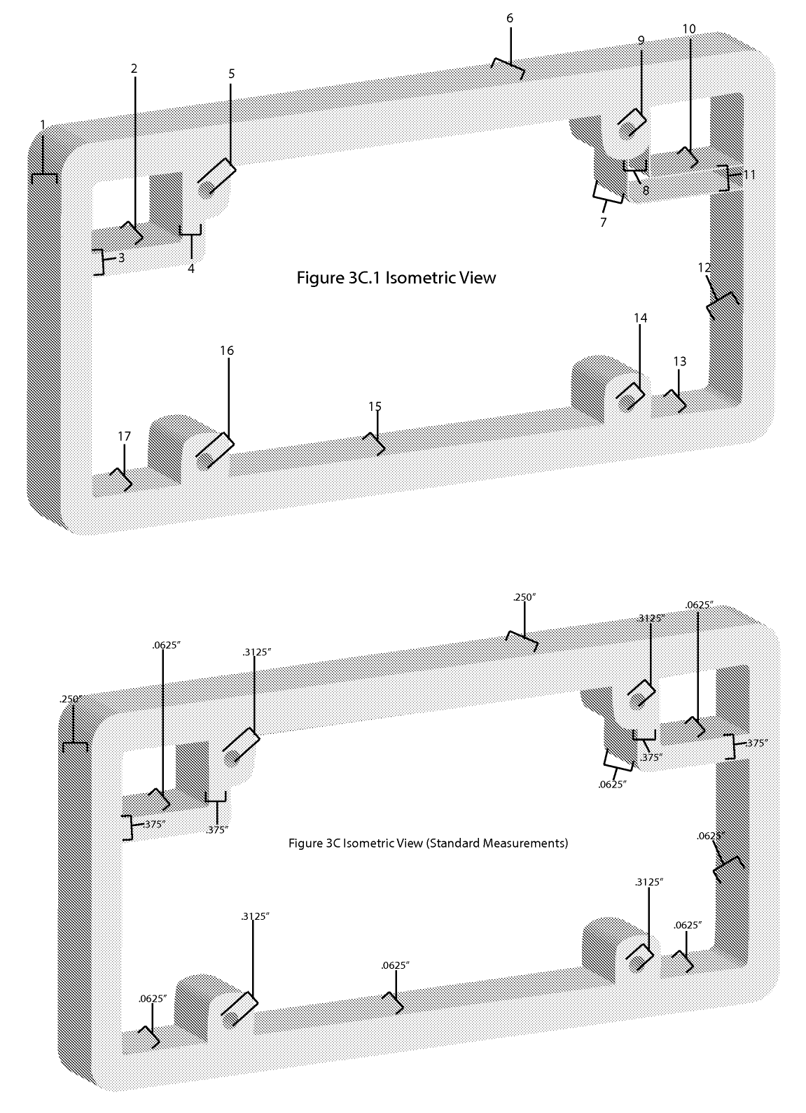

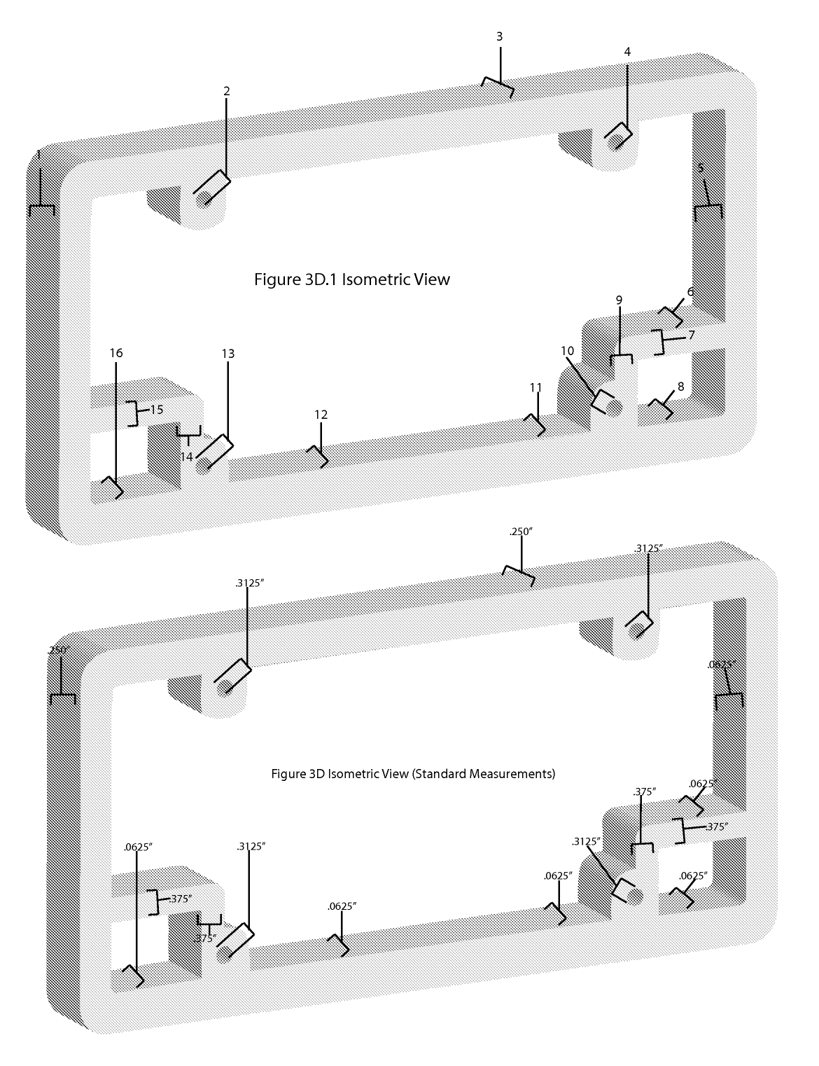

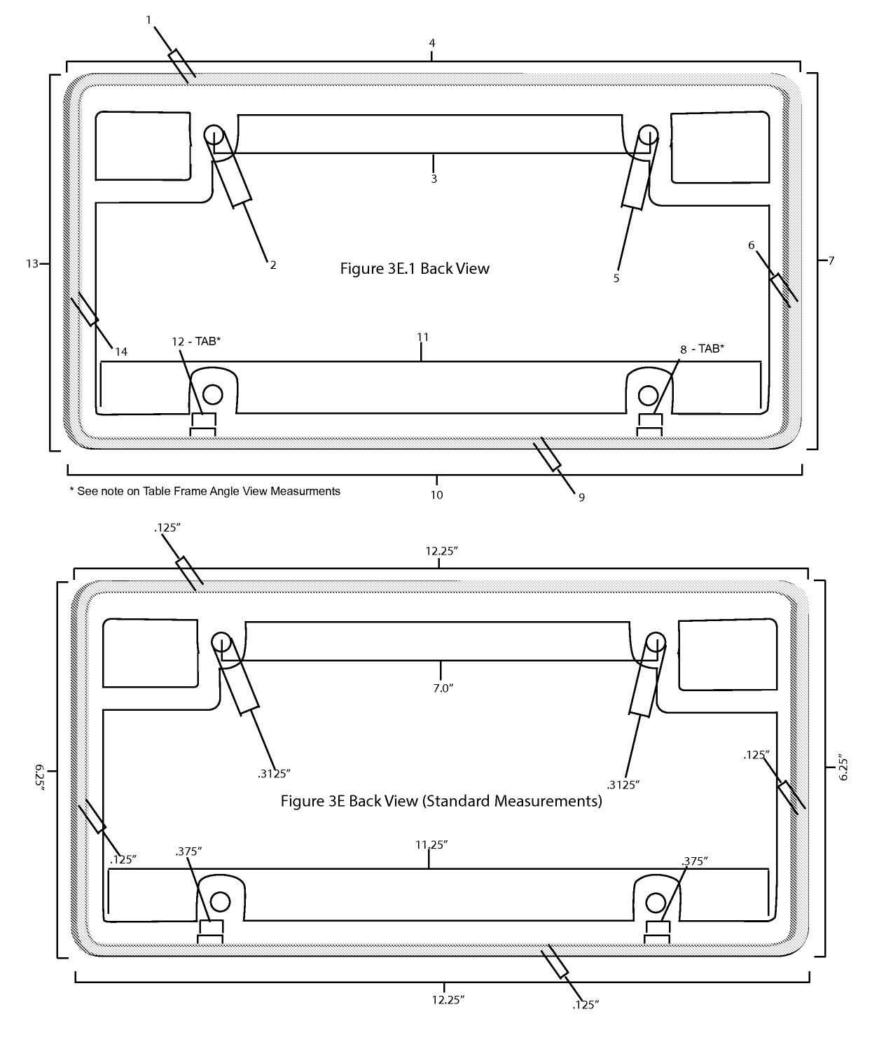

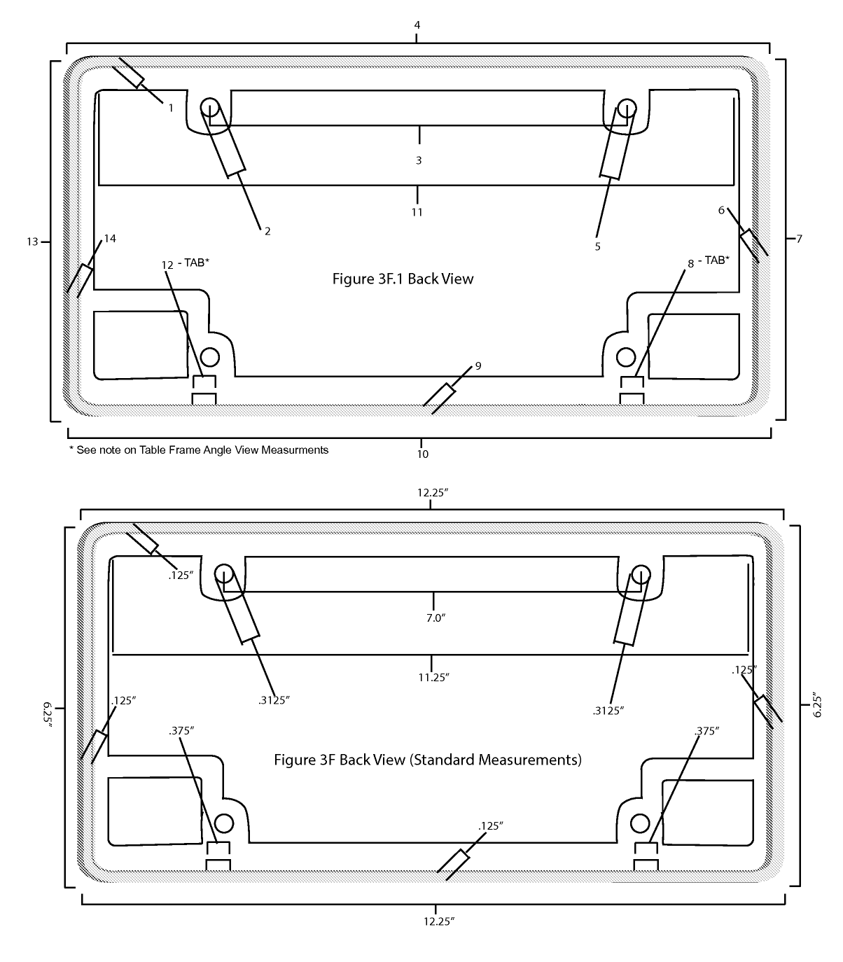

FIG. 3 is a front top elevation view of the tag protector back of vehicle frame design showing possible placements of the loop based on various state regulatory specifications by way of example only and is not intended to be limiting of loop placement;

FIG. 3A is a front top elevation view of the tag protector back of vehicle frame design showing only the bottom corner positioning of the loops and listing standard sizes by way of example only and is not intended to be limiting nor reflecting all possible loop placements or sizes.

FIG. 3A.1 is a front top elevation view of the tag protector back of vehicle frame design showing only the bottom corner positioning of the loops and calling out various component parts of the design to be detailed in the claims, by way of example only; and, is not intended to be limiting nor reflective of all possible loop placements.

FIG. 3B is an isometric view of the tag protector back of vehicle frame design showing only the bottom corner positioning of the loops and listing standard sizes by way of example only and is not intended to be limiting nor reflecting all possible loop placements or sizes.

FIG. 3B.1 is an isometric view of the tag protector back of vehicle frame design showing only the bottom corner positioning of the loops and calling out various component parts of the design to be detailed in the claims, by way of example only; and, is not intended to be limiting nor reflective of all possible loop placements.

FIG. 3C is a back elevation view of the tag protector back of vehicle frame design showing only the bottom corner positioning of the loops and listing standard sizes by way of example only and is not intended to be limiting nor reflecting all possible loop placements or sizes.

FIG. 3C.1 is a back elevation view of the tag protector back of vehicle frame design showing only the bottom corner positioning of the loops and calling out various component parts of the design to be detailed in the claims, by way of example only; and, is not intended to be limiting nor reflective of all possible loop placements.

FIG. 3D is a front top elevation view of the tag protector back of vehicle frame design showing only the top corner positioning of the loops and listing standard sizes by way of example only and is not intended to be limiting nor reflecting all possible loop placements or sizes.

FIG. 3D.1 is a front top elevation view of the tag protector back of vehicle frame design showing only the top corner positioning of the loops and calling out various component parts of the design to be detailed in the claims, by way of example only; and, is not intended to be limiting nor reflective of all possible loop placements.

FIG. 3E is an isometric view of the tag protector back of vehicle frame design showing only the top corner positioning of the loops and listing standard sizes by way of example only and is not intended to be limiting nor reflecting all possible loop placements or sizes.

FIG. 3E.1 is an isometric view of the tag protector back of vehicle frame design showing only the top corner positioning of the loops and calling out various component parts of the design to be detailed in the claims, by way of example only; and, is not intended to be limiting nor reflective of all possible loop placements.

FIG. 3F is a back elevation view of the tag protector back of vehicle frame design showing only the top corner positioning of the loops and listing standard sizes by way of example only and is not intended to be limiting nor reflecting all possible loop placements or sizes.

FIG. 3F.1 is a back elevation view of the tag protector back of vehicle frame design showing only the top corner positioning of the loops and calling out various component parts of the design to be detailed in the claims, by way of example only; and, is not intended to be limiting nor reflective of all possible loop placements.

NOTE: FIGS. 3, 3A, 3A.1, 3B, 3B.1, 3C, 3C.1, 3D, 3D.1, 3E, 3E.1, 3F, and 3F.1 depict tag protector back of vehicle frame design with mounting holes shown on both top and bottom horizontal planar views as an illustrative view of the design and is not intended to be limiting the scope or design of the current invention. Hole placement may vary based on operating vehicle requirements

### Front Vehicle Frame

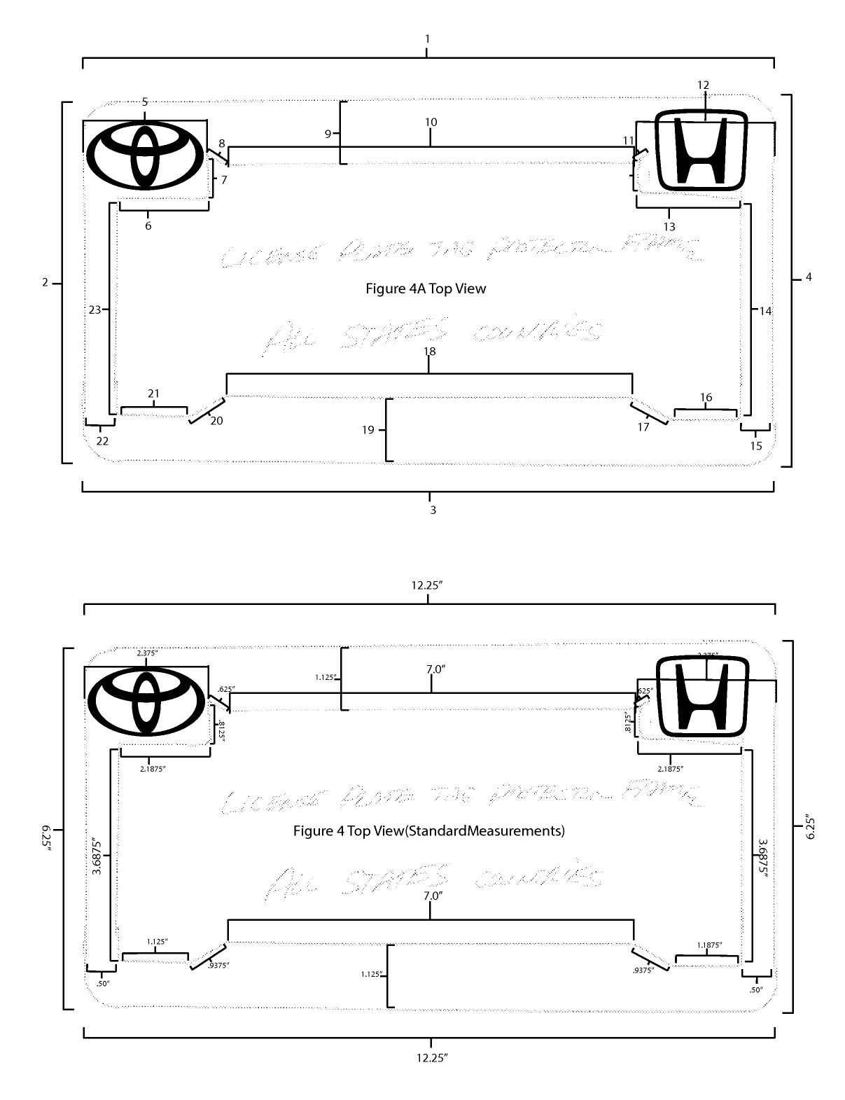

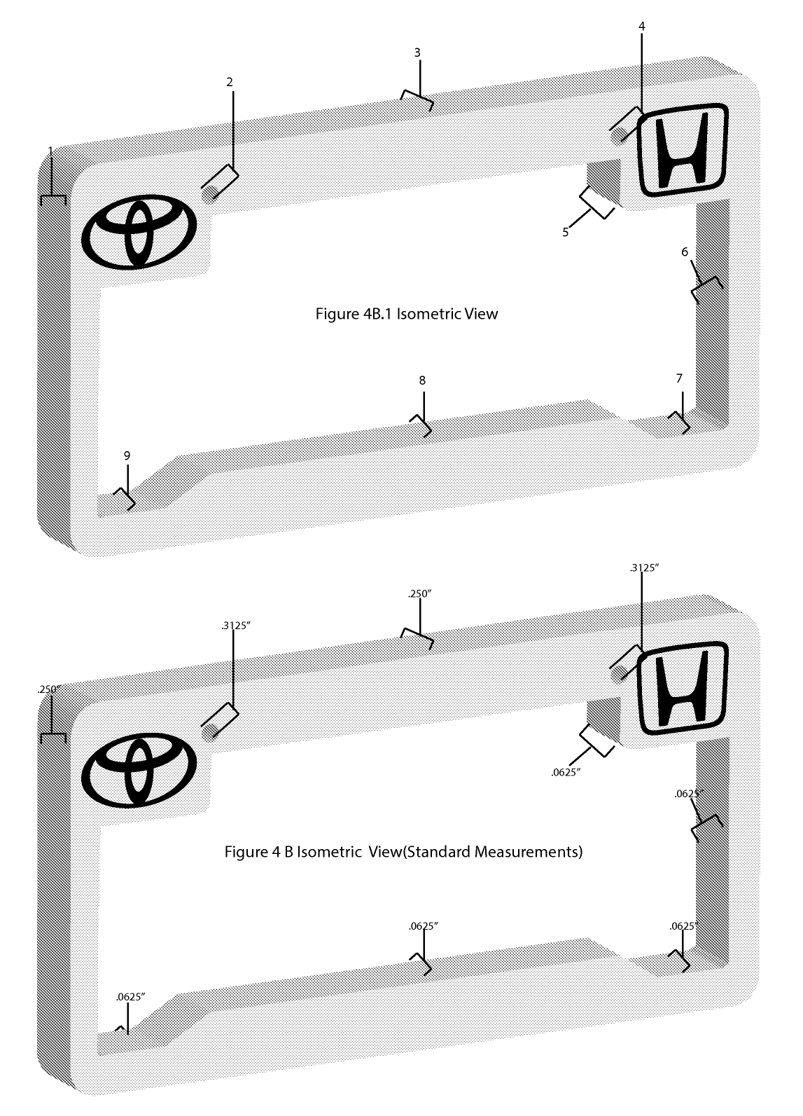

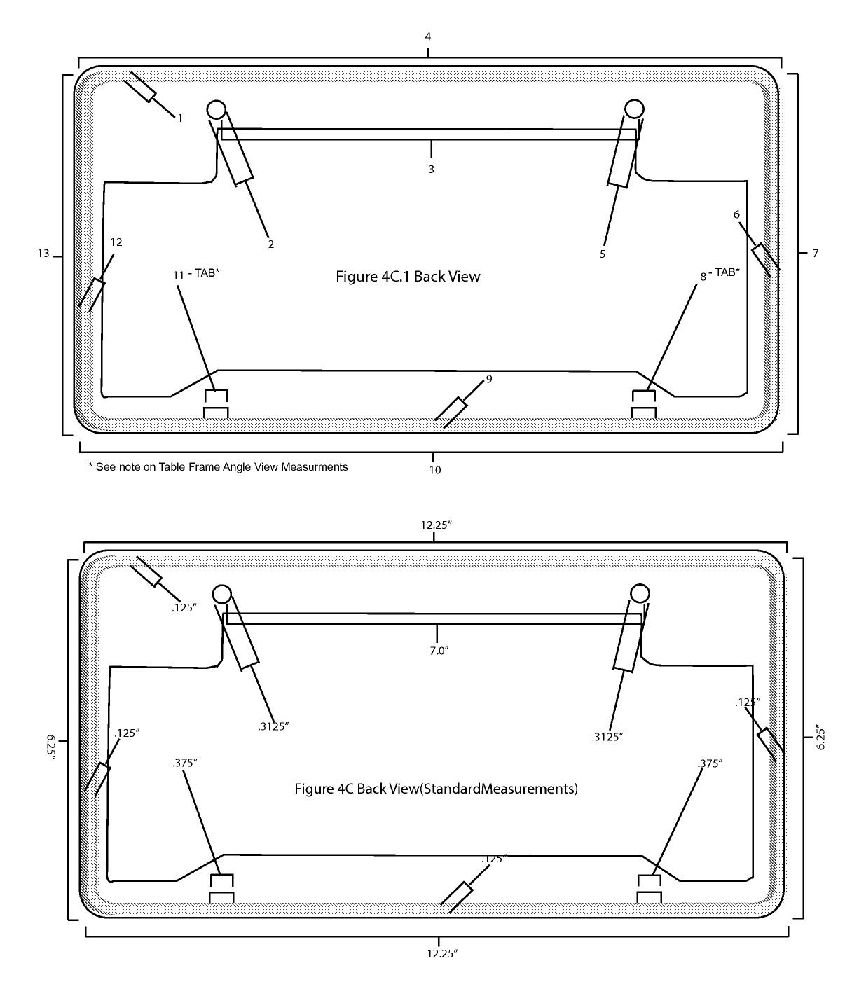

FIG. 4 is a front top elevation view of the tag protector front of vehicle frame design showing only the top corner positioning of the solid loops and improved advertising space; and, listing standard sizes by way of example only and is not intended to be limiting nor reflecting all possible solid loop placements or sizes.

FIG. 4A is a front top elevation view of the tag protector front of vehicle frame design showing only the top corner positioning of the solid loops and improved advertising space; and, calling out various component parts of the design to be detailed in the claims, by way of example only; and, is not intended to be limiting nor reflective of all possible solid loop placements.

FIG. 4B is an isometric view of the tag protector front of vehicle frame design showing only the top corner positioning of the solid loops and improved advertising space; standard sizes by way of example only and is not intended to be limiting nor reflecting all possible solid loop placements or sizes.

FIG. 4B.1 is an isometric view of the tag protector front of vehicle frame design showing only the top corner positioning of the solid loops and improved advertising space; and, calling out various component parts of the design to be detailed in the claims, by way of example only; and, is not intended to be limiting nor reflective of all possible solid loop placements.

FIG. 4C is a back elevation view of the tag protector front of vehicle frame design showing only the top corner positioning of the solid loops and improved advertising space; and listing standard sizes by way of example only and is not intended to be limiting nor reflective of all possible solid loop placements.

FIG. 4C.1 is a back elevation view of the tag protector front of vehicle frame design showing only the top corner positioning of the solid loops and improved advertising space; and calling out various component parts of the design to be detailed in the claims, by way of example only; and, is not intended to be limiting nor reflective of all possible solid loop placements.

All dimensions specified in this disclosure are by way of example only and are not intended to be limiting. Further, the proportions shown in these Figures are not necessarily to scale. As will be understood by those with skill in the art with reference to this disclosure, the actual dimensions of any device or part of a device disclosed in this disclosure will be determined by their intended use.

Any broken line illustration in the drawing is not part of the design sought to be patented. In addition, any ornamental design embodied in the illustrations is only for illustrative purposes and forms no part of the claimed design.

### DETAILED DESCRIPTION AND SPECIFICATIONS

The current invention provides a significant departure from the design in the current art and is a preferred embodiment of a customizable license plate frame as disclosed in FIGS. 1-4, utilizing both a solid and non-solid loop structure to cover a vehicle registration sticker thereby acting as a deterrent of tag theft, improved advertising design space, and protection of wear and tear on a license plate. As mentioned in the Abstract, the invention is an improved license plate and tag protector, comprised in a single piece, and made of plastic (with an SPI code of 1-7), stainless steel, zinc alloy, brass, wood, and/or can be made with any other material that may be formed and/or constructed through molding and/or non-molding processes and/or devices into the current inventions design. The license plate tag protector further comprises an improved structural technique for positioning and securing registration and or identifying decals on license plates mitigating propensity for theft, wear and tear. A method of making a license plate tag protector as described can both be made with and without molding devices based on material selection. The invention calls for both front and back plate structural specifications as indicated above.

The foregoing description of the invention has been presented for purposes of illustration and description and is not intended to be exhaustive or to limit the invention to the precise form disclosed. Many modifications and variations are possible. By way of example:

Frame Angle View Measurements

| | FIG. | FIG. | FIG. | FIG. | FIG. | FIG. | FIG. | FIG. | FIG. | FIG. | FIG. | FIG. | FIG. | FIG. | FIG. |
|---|---|---|---|---|---|---|---|---|---|---|---|---|---|---|---|
| | 1A.1 | 1B.1 | 1C.1 | 2A.1 | 2B.1 | 2C.1 | 3A.1 | 3B.1 | 3C.1 | 3D.1 | 3E.1 | 3F.1 | 4 | 4B.1 | 4C.1 |
| | Top | Iso | Back | Top | Iso | Back | Top | Iso | Back | Top | Iso | Back | Top | Iso | Back |
| Parts | View | View | View | View | View | View | View | View | View | View | View | View | View | View | View |
| 1 | .01-36 | 0-6 | .01-16 | .01-36 | 0-6 | .01-16 | .01-36 | 0-6 | .01-16 | .01-36 | 0-6 | .01-16 | .01-36 | 0-6 | .01-16 |
| 2 | .01-16 | .0125-6 | 0-10 | .01-16 | .0125-6 | 0-10 | .01-16 | 0-10 | 0-10 | .01-16 | .0125-6 | 0-10 | .01-16 | 0-10 | 0-10 |
| 3 | .01-36 | .01-16 | .01-36 | .01-36 | .01-16 | .01-36 | .01-36 | 0-6 | .01-36 | .01-36 | .01-16 | .01-36 | .01-36 | 0-6 | .01-36 |
| 4 | .01-16 | .01-36 | .01-36 | .01-16 | .01-36 | .01-36 | .01-16 | 0-10 | .01-36 | .01-16 | .01-36 | .01-36 | .01-16 | 0-10 | .01-36 |
| 5 | .01-36 | 0-10 | 0-10 | .01-36 | 0-10 | 0-10 | .01-36 | .0125-6 | 0-10 | .01-36 | 0-10 | 0-10 | .01-36 | .0125-6 | 0-10 |
| 6 | .01-16 | 0-6 | .01-16 | .01-16 | 0-6 | .01-16 | .01-16 | .0125-6 | .01-16 | .01-16 | 0-6 | .01-16 | .01-36 | .0125-6 | .01-16 |
| 7 | .01-36 | .0125-6 | .01-16 | .01-36 | .0125-6 | .01-16 | .01-36 | .01-16 | .01-16 | .01-16 | .0125-6 | .01-16 | .01-16 | .0125-6 | .01-16 |
| 8 | .01-24 | .01-36 | 0-36 | .01-24 | .01-36 | 0-36 | 0-36 | .0125-6 | 0-36 | .01-16 | .01-36 | 0-36 | .01-24 | .0125-6 | 0-36 |
| 9 | .01-16 | 0-10 | .01-16 | .01-16 | 0-10 | .01-16 | .01-36 | .01-36 | .01-16 | .01-36 | 0-10 | .01-16 | .01-16 | .0125-6 | .01-16 |
| 10 | .01-24 | .0125-6 | .01-36 | .01-24 | .0125-6 | .01-36 | 0-16 | 0-10 | .01-36 | .01-36 | .0125-6 | .01-36 | .01-36 | | .01-36 |
| 11 | .01-16 | .01-16 | 0-36 | .01-16 | .01-16 | .01-36 | .01-36 | .0125-6 | .01-36 | .01-16 | .0125-6 | 0-36 | .01-24 | | 0-36 |
| 12 | .01-36 | .0125-6 | .01-16 | .01-36 | .0125-6 | 0-36 | .01-36 | .0125-6 | 0-36 | .01-36 | .0125-6 | .01-16 | .01-36 | | .01-16 |
| 13 | .01-36 | .0125-6 | .01-16 | .01-36 | .0125-6 | .01-16 | .01-36 | 0-10 | .01-16 | .01-36 | .0125-6 | .01-16 | .01-36 | | .01-16 |
| 14 | .01-16 | .0125-6 | | .01-16 | .0125-6 | .01-16 | .01-16 | .01-36 | .01-16 | .01-16 | 0-10 | | 0-16 | | |
| 15 | .01-36 | .0125-6 | | .01-36 | .0125-6 | | .01-36 | .01-16 | | .01-36 | .0125-6 | | .01-36 | | |
| 16 | .01-24 | | | .01-24 | | | .01-16 | .0125-6 | | .01-36 | 0-10 | | 0-36 | | |
| 17 | .01-36 | | | .01-36 | | | .01-36 | | | .01-16 | .0125-6 | | .01-24 | | |
| 18 | .01-16 | | | .01-16 | | | .01-16 | | | 0-16 | | | .01-36 | | |
| 19 | .01-36 | | | .01-36 | | | .01-36 | | | .01-36 | | | .01-16 | | |
| 20 | .01-24 | | | .01-24 | | | .01-36 | | | 0-36 | | | .01-24 | | |
| 21 | .01-16 | | | .01-16 | | | .01-16 | | | .01-36 | | | 0-36 | | |
| 22 | .01-16 | | | .01-16 | | | .01-16 | | | .01-16 | | | .01-36 | | |
| 23 | .01-36 | | | .01-36 | | | 0-36 | | | .01-36 | | | 0-16 | | |
| 24 | .01-36 | | | .01-36 | | | | | | 0-16 | | | .01-16 | | |
| 25 | 0-16 | | | 0-16 | | | | | | | | | | | |
| 26 | .01-36 | | | .01-36 | | | | | | | | | | | |
| 27 | 0-36 | | | 0-36 | | | | | | | | | | | |
| 28 | .01-24 | | | .01-16 | | | | | | | | | | | |
| 29 | 0-36 | | | .01-36 | | | | | | | | | | | |
| 30 | .01-16 | | | 0-16 | | | | | | | | | | | |
| 31 | .01-24 | | | | | | | | | | | | | | |
| 32 | 0-36 | | | | | | | | | | | | | | |
| 33 | .01-36 | | | | | | | | | | | | | | |
| 34 | 0-16 | | | | | | | | | | | | | | |

Note 1:
Measurements all listed in inches
Note 2:
Listed measurement is a range
Note 3:
The invention is an improved license plate and tag protector, comprised in a single/multiple piece(s), and made of plastic (with an SPI code of 1-7), stainless steel, zinc alloy, brass, wood, and/or can be made with any material that may be formed and/or constructed through molding and/or non-molding processes and/or devices into the current inventions design.
Note 4:
Materials can be any color with or without decoration
Note 5:
Each part for purposes of the claim includes multiple or singular pieces of each part
Tab^{a}-Not part of design, tab(s) based on manufacturing processes, can be with or without tab(s)

The embodiments of the current invention are for illustrative purposes only and should not be construed as limiting the scope of the current invention and/or its protections. The scope of the invention is to be defined by the following claims.

What I claim is:

1. A license plate holder and tag protector, any shape or color in scope, and comprised of any material by means of molding or non-molding process and/or devices, adapted to receive a plate, and/or protect registration and/or identifying decals. The frame including two vertical end pieces, a top horizontal piece, a bottom horizontal piece, with inwardly or outwardly extending, interior and/or exterior loop-like structures as depicted in the product description herein, in any shape; and, integrally connected to either end and/or both the horizontal and vertical ends, in various positions to prevent the loss and/or theft of registration and/or identifying decals and advertising space.

2. A license plate holder and tag protector, any shape or color in scope, and comprised of any material by means of molding or non-molding process and/or devices as defined in claim 1 wherein said loop placement is covered under this claim for back of vehicle frame. For front of vehicle claim loop placement may vary.

3. A license plate holder and tag protector, any shape or color in scope, and comprised of any material by means of molding or non-molding process and/or devices as defined in claim 2 wherein the thickness may vary from 0 inches and higher and further defined in Table 1 Frame Angle View Measurements and notes.

4. A license plate holder and tag protector, any shape or color in scope, and comprised of any material by means of molding or non-molding process and/or devices as defined in claim 3, with or without holes, and regardless of hole placement.

5. A license plate holder and tag protector, any shape or color in scope, and comprised of any material by means of molding or non-molding process and/or devices as defined in claim 4 wherein the overall frame size as defined by Table 1 Frame Angle View Measurements and notes.

6. A license plate holder and tag protector, any shape or color in scope, and comprised of any material by means of molding or non-molding process and/or devices as defined in claim 5 wherein the angular variation of depth as defined by Table 1 Frame Angle View Measurements and notes.

7. A license plate holder and tag protector, any shape or color in scope, and comprised of any material by means of molding or non-molding process and/or devices as defined in claim 6 wherein the vertical and horizontal side planar walls are all inclusive as defined by Table 1 Frame Angle View Measurements and notes.

8. A license plate holder and tag protector, any shape or color in scope, and comprised of any material by means of molding or non-molding process and/or devices as defined in claim 7 wherein the structural element can be created with multiple pieces.

9. A license plate holder and tag protector, any shape or color in scope, and comprised of any material by means of molding or non-molding process and/or devices as defined in claim 8; wherein loops are added to existing designs and/or utility.
